(19) United States
(12) Patent Application Publication
(10) Pub. No.: US 2026/0312387 A1
(43) Pub. Date: Oct. 8, 2026

(54) WIRE HARNESS

(71) Applicant: SUMITOMO WIRING SYSTEMS, LTD., Yokkaichi-shi (JP)

(72) Inventor: Yoshiki KAWADE, Yokkaichi-shi (JP)

(73) Assignee: SUMITOMO WIRING SYSTEMS, LTD., Yokkaichi-shi (JP)

(21) Appl. No.: 19/634,776

(22) Filed: Mar. 31, 2026

(30) Foreign Application Priority Data
Apr. 4, 2025 (JP) 2025-062502

(51) Int. Cl. H02G 3/04; H01B 7/00

(52) U.S. Cl. CPC H02G 3/0468; H01B 7/0045

(57) ABSTRACT

A wire harness including: an electric wire that includes a core wire, an insulating coating that accommodates the core wire, a braid that covers the insulating coating, and a sheath that covers the braid; and a tubular ferrule that is disposed between an end of the braid and the insulating coating, wherein the end of the braid is fixed using a fixing member in a state in which the ferrule is laid under the end of the braid, and the ferrule has an insertion portion that is inserted between the braid covered by the sheath and an outer circumferential surface of the insulating coating and is positioned relative to the electric wire before fixation using the fixing member.

### BACKGROUND

The present disclosure relates to a wire harness.

Conventionally, as disclosed in JP 2023-131888A, a shielded electric wire that includes a core portion formed by coating a conductive wire with an insulating coating, a braided wire disposed on the outer circumference of the core portion, and a casing covering the outer circumference of the braided wire is well known. In this shielded electric wire, an inner ferrule is attached to the outer circumference of the braid folded back toward a side opposite to the leading end of the electric wire. Then, the leading end of the braided wire is further folded back so as to cover the outer circumference of the inner ferrule, and an outer ferrule is attached to the outer circumference of this folded-back portion. The inner ferrule and the outer ferrule are crimped with the braided wire being interposed therebetween.

### SUMMARY

When being fitted to the outer circumference of the core portion of the electric wire, the inner ferrule is merely disposed on the outer circumference of the braided wire. Accordingly, locational shifting of the inner ferrule may occur relative to the core portion of the electric wire, specifically the braided wire, when, for example, the outer ferrule is crimped. As a countermeasure for this locational shifting, it can be considered that, for example, the inner ferrule is crimped to the core portion in advance through swaging. However, if this countermeasure is taken, a dedicated tool is required, which leads to a concern that the workability for assembling the shielded electric wire will be deteriorated.

An exemplary aspect of the disclosure provides a wire harness in which a ferrule can be positioned using a simple structure.

A wire harness for solving the aforementioned problems includes: an electric wire that includes a core wire, an insulating coating that accommodates the core wire, a braid that covers the insulating coating, and a sheath that covers the braid; and a tubular ferrule that is disposed between an end portion of the braid and the insulating coating, wherein the end portion of the braid is fixed using a fixing member in a state in which the ferrule is laid under the end portion of the braid, and the ferrule has an insertion portion that is inserted between the braid covered by the sheath and an outer circumferential surface of the insulating coating and is positioned relative to the electric wire before the fixation using the fixing member.

With the present disclosure, a ferrule can be positioned using a simple structure.

### BRIEF DESCRIPTION OF THE DRAWINGS

FIG. 1 is a perspective view showing the external appearance of a wire harness according to an embodiment;

FIG. 2 is a cross-sectional view taken along line II-II shown in FIG. 6;

FIG. 3 is a cross-sectional view of the wire harness;

FIG. 4 is a perspective view of a ferrule as viewed obliquely from a base end side;

FIG. 5 is a perspective view of the ferrule as viewed obliquely from a leading end side;

FIG. 6 is a perspective view of an electric wire to which the ferrule is attached;

FIG. 7 is a side view of the ferrule; and

FIGS. 8A to 8C are diagrams illustrating the procedure for engaging the ferrule with a braid.

### EMBODIMENTS OF THE DISCLOSURE

First, aspects of the present disclosure will be listed and described.

A wire harness of the present disclosure includes: an electric wire that includes a core wire, an insulating coating that accommodates the core wire, a braid that covers the insulating coating, and a sheath that covers the braid; and a tubular ferrule that is disposed between an end portion of the braid and the insulating coating, wherein the end portion of the braid is fixed using a fixing member in a state in which the ferrule is laid under the end portion of the braid, and the ferrule has an insertion portion that is inserted between the braid covered by the sheath and an outer circumferential surface of the insulating coating and is positioned relative to the electric wire before the fixation using the fixing member.

With this configuration, by inserting the insertion portion formed in the ferrule into the space between the insulating coating and the braid of the electric wire, the ferrule is positioned relative to the electric wire due to a press-fitting load applied from the sheath covering the braid. Accordingly, the locational shifting of the ferrule is less likely to occur when another component is attached after the ferrule has been attached to the electric wire. Therefore, the workability for assembling the wire harness is improved. The ferrule positioning structure is merely configured such that the insertion portion formed in the ferrule is inserted between the insulating coating and the braid. Accordingly, the ferrule can be positioned using a simple structure.

In the above aspect 1, the insertion portion has a tubular shape. With this configuration, in the insertion portion of the ferrule, an area to which a press-fitting load from the sheath is applied can be expanded in the circumferential direction of the ferrule, and it is thus possible to make it much less likely that the locational shifting of the ferrule occurs.

3 In the above aspect 1 or 2, the ferrule has: a base end portion that has a larger diameter than the insertion portion and is continuous with the insertion portion; and a wall portion located at a boundary between the insertion portion and the base end portion, and is positioned relative to the electric wire in a state in which the wall portion is located at a position close to an end portion of the sheath. With this configuration, the position in the axial direction at which the ferrule is disposed relative to the electric wire is a position at which the wall portion of the ferrule is the closest to the end portion of the sheath. Accordingly, when the position of the ferrule relative to the electric wire is adjusted in the axial direction, the ferrule need only be linearly moved to a position at which the wall portion of the ferrule cannot be moved due to the end portion of the sheath, and thus the ferrule can be easily positioned. Also, due to a press-fitting load being applied to the insertion portion from the sheath, the locational shifting of the ferrule disposed at this position is less likely to occur.

4 In the above aspect [3], the wall portion has a tapered shape that tapers off toward the insertion portion from the base end portion. With this configuration, when the insertion portion of the ferrule is inserted into the space between the insulating coating and the braid, the leading end of the braid is guided by the tapered wall portion and smoothly reaches the base end portion of the ferrule. Therefore, this configuration further contributes to an improvement in the workability for assembling the wire harness.

5 In the above aspect [3] or [4], a corner portion located at a boundary between the wall portion and the base end portion has a curved surface shape. With this configuration, when the insertion portion of the ferrule is inserted into the space between the insulating coating and the braid, the leading end of the braid is less likely to be damaged by the corner portion of the wall portion while the leading end of the braid passes the corner portion.

6 In any one of the above aspects [3] to [5], a length of the insertion portion in an axial direction is set to a value that is two to three times as long as a length of the base end portion in the axial direction. With this configuration, in the insertion portion of the ferrule, an area to which a press-fitting load from the sheath is applied can be expanded in the axial direction of the ferrule, and it is thus possible to make it much less likely that the locational shifting of the ferrule occurs.

### Details of Embodiments of the Present Disclosure

The following describes specific examples of the present disclosure with reference to the drawings. Note that the present disclosure is not limited to these examples and is defined by the scope of the appended claims, and all changes that fall within the same essential spirit as the scope of the claims are intended to be included therein. A portion of the configuration may be exaggerated or simplified for illustrative purposes in the diagrams. In addition, the ratios between the dimensions of portions shown in the diagrams may be different from the actual ratios.

### Wire Harness 1

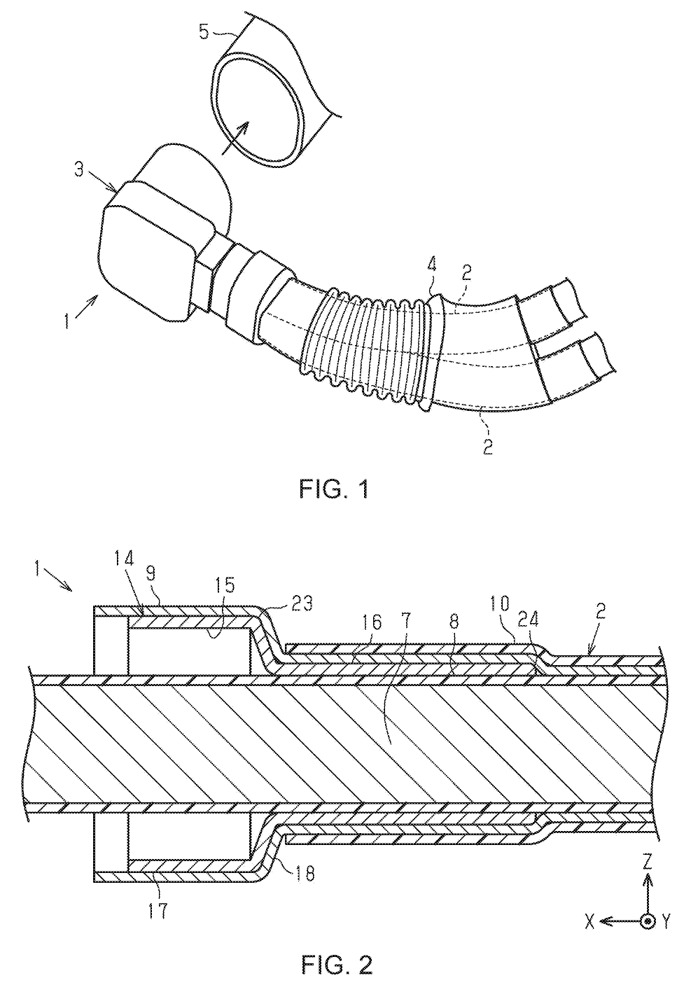

As shown in FIG. 1, a wire harness 1 includes electric wires 2 for electrically connecting apparatuses, and a connector 3 attached to the leading ends of the electric wires 2. A pair of the electric wires 2 is provided. One is a positive wire and the other is a negative wire. A protective member 4 is attached to the leading ends of the electric wires 2 and covers the periphery of the electric wires 2 at a portion to be connected to the connector 3. The protective member 4 is, for example, a rubber boot.

The connector 3 is to be connected to a counterpart connector 5 provided on an attachment target of the wire harness 1. When the wire harness 1 is used in a vehicle, the attachment target of the wire harness 1 is, for example, the vehicle body. At least a portion of the wire harness 1 is located outside the vehicle.

The wire harness 1 electrically connects, for example, two or more in-vehicle apparatuses. Examples of the in-vehicle apparatuses include a high-voltage battery, an inverter, a motor, an electrical junction box, and the like. Examples of the electrical junction box include a relay box, a fuse box, a junction box, and the like. In this example, the wire harness 1 electrically connects an inverter and a battery.

### Electric Wire 2

As shown in FIG. 2, each of the electric wires 2 includes a core wire 7 having electrical conductivity, and an insulating coating 8 that accommodates the core wire 7. The insulating coating 8 covers the outer circumferential surface of the core wire 7 over the entire length in the circumferential direction thereof. The insulating coating 8 is made of, for example, an insulating resin material. In the electric wire 2, a terminal (not illustrated) to be electrically connected to the counterpart connector 5 is attached and fixed to the leading end of the core wire 7.

The electric wire 2 includes a braid 9 that covers the insulating coating 8, and a sheath 10 that covers the outer circumferential surface of the braid 9. As described above, the electric wire 2 of this example is a shielded electric wire that includes the core wire 7, the insulating coating 8, the braid 9, and the sheath 10 in this order from the center toward the outside in the radial direction. The braid 9 is formed by, for example, braiding a plurality of metallic strands into a tubular shape. For example, a metal material such as a copper-based material or an aluminum-based material is used as the material of the braid 9. For example, the sheath 10 is a coating material made of a resin, and surrounds and protects the braid 9.

### Connector 3

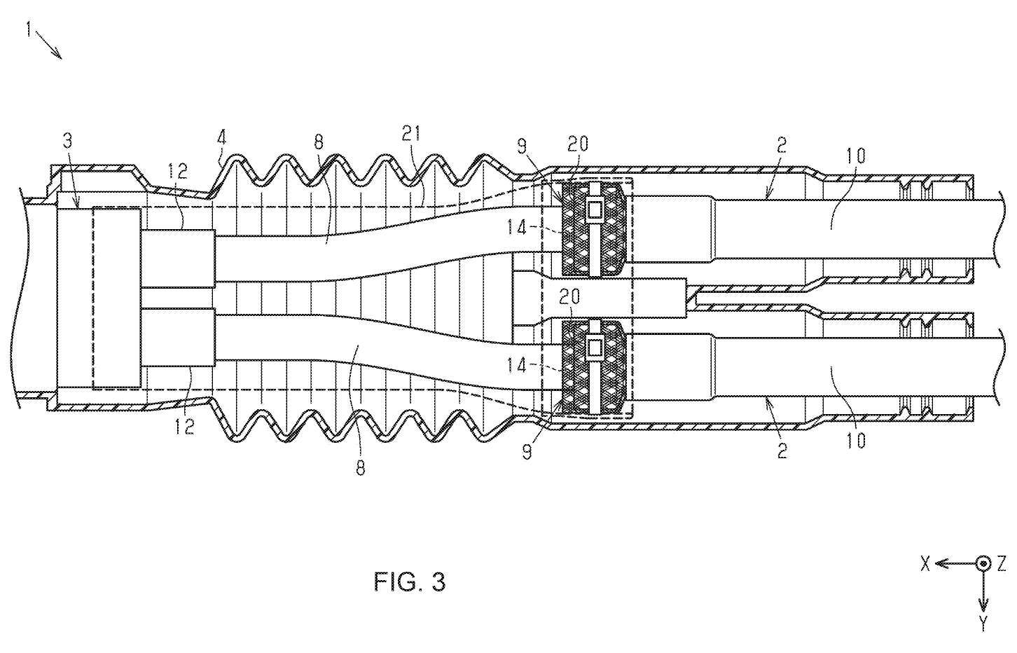

As shown in FIG. 3, the connector 3 includes connection portions 12 to which the leading ends of the electric wires 2 are fitted. One of the electric wires 2 is connected to one of a pair of the connection portions 12, and the other of the electric wires 2 is connected to the other of the pair of the connection portions 12. The connector 3 is fitted to the protective member 4 such that a portion thereof that includes the connection portions 12 is accommodated inside the protective member 4.

### Ferrule 14

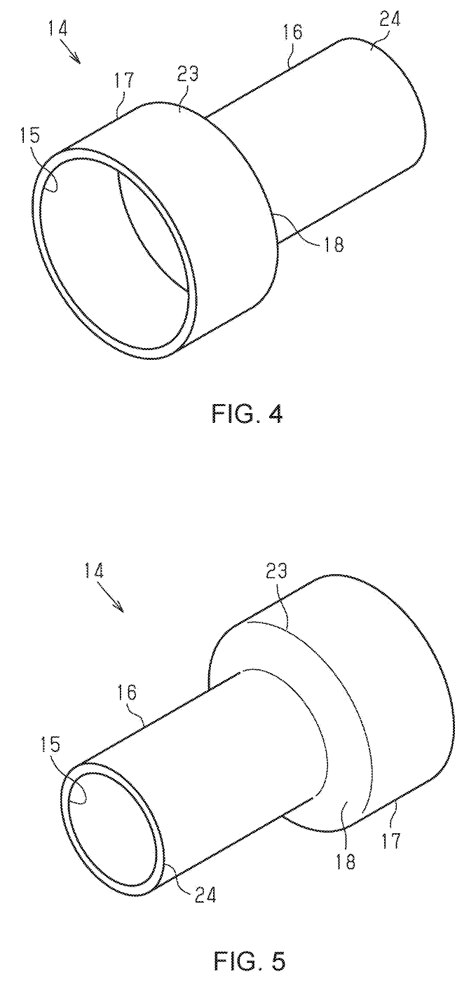

As shown in FIGS. 4 and 5, the wire harness 1 includes ferrules 14 used for processing of the ends of the braids 9. For example, each of the ferrules 14 has a substantially tubular shape and is made of a metal using copper or the like as a material. The ferrule 14 is attached to the electric wire 2 such that the core wire 7 and the insulating coating 8 are inserted through a hole 15.

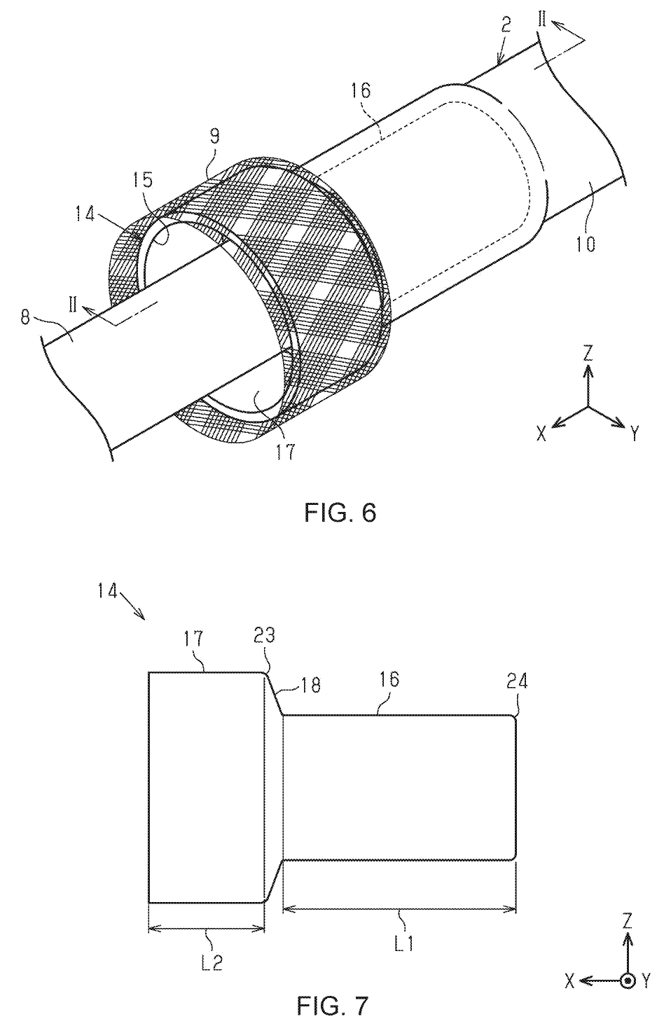

As shown in FIGS. 2 and 6, the ferrule 14 has an insertion portion 16 inserted between the insulating coating 8 and the braid 9, a base end portion 17 exposed from the sheath 10, and a wall portion 18 located at the boundary between the insertion portion 16 and the base end portion 17. Thus, the ferrule 14 of this example has a shape in which the diameter changes at an intermediate portion in the axial direction. The base end portion 17 has a larger diameter than the insertion portion 16, and is continuous with the insertion portion 16. The insertion portion 16 and the base end portion 17 are both formed in a tubular shape (cylindrical shape) and are concentric with each other.

As shown in FIG. 2, the base end portion 17 of the ferrule 14 is located between the end portion of the braid 9 and the insulating coating 8. The ferrule 14 is disposed at a position at which the wall portion 18 is the closest to the end portion of the sheath 10 in the axial direction of the ferrule 14 (X-axis direction in FIG. 2). That is to say, the ferrule 14 is brought close to the end portion of the sheath 10 and is thus disposed near the end portion of the sheath 10.

### Processing of End of Braid 9

As shown in FIG. 3, the end portion of the braid 9 is fixed using a fixing member 20 in a state in which the ferrule 14 is laid under the end portion of the braid 9. The fixing member 20 may be, for example, a metallic tie band, which is one type of binding members. The end portion of the braid 9 is fixed to the base end portion 17 of the ferrule 14 via the fixing member 20 attached to the outer circumferential surface. In this example, the end portion of the braid 9 is fixed to the base end portion 17 of the ferrule 14 by swaging the fixing member 20.

A bundling braid 21 for electrically connecting a pair of the braids 9 to a GND terminal of the counterpart connector 5 is attached to the braids 9. The bundling braid 21 is formed by braiding a plurality of metallic strands, and electrically connects both of the pair of the braids 9 to the GND terminal of the counterpart connector 5. The bundling braid 21 of this example has a tubular shape having a length from the pair of the braids 9 to the counterpart connector 5.

When the metallic tie band is used as the fixing member 20, the braid 9 and the bundling braid 21 are collectively fixed to the ferrule 14 by, for example, passing the leading end of the band through a hole (not illustrated) formed in the bundling braid 21 and fixing this leading end of the band to a binding portion. That is to say, the metallic tie band serving as the fixing member 20 fixes both the braid 9 and the bundling braid 21 to the ferrule 14. Note that an excess portion of the bundling braid 21 after the attachment of the fixing member 20 is folded back toward the opposite side and is thus accommodated.

### Positioning of Ferrule 14

As shown in FIGS. 2 and 6, before the fixation with the fixing member 20, the insertion portion 16 of the ferrule 14 is inserted between the braid 9 covered by the sheath 10 and the outer circumferential surface of the insulating coating 8 and is positioned relative to the electric wire 2. In this example, by inserting the insertion portion 16 into a narrow space between the insulating coating 8 and the braid 9, the ferrule 14 is positioned relative to the electric wire 2 due to a press-fitting load applied from the sheath 10. As shown in FIG. 2, the ferrule 14 is positioned relative to the electric wire 2 in the state in which the wall portion 18 is located at a position close to the end portion of the sheath 10.

As shown in FIG. 7, a length L1 of the insertion portion 16 in the axial direction (the X-axis direction in FIG. 7) is set to a value that is two to three times as long as a length L2 of the base end portion 17 in the axial direction (the X-axis direction in FIG. 7). As described above, the length L1 of the insertion portion 16 of the ferrule 14 in the axial direction is longer than the length L2 of the base end portion 17 of the ferrule 14 in the axial direction in order to increase an area of a press-fitting load applied from the sheath 10 to the insertion portion 16.

### Wall Portion 18

As shown in FIG. 7, the wall portion 18 has a tapered shape that tapers off toward the insertion portion 16 from the base end portion 17. The wall portion 18 is formed over the entire length of the circumferential direction about the axis of the ferrule 14. A corner portion 23 located at the boundary between the wall portion 18 and the base end portion 17 has a curved surface shape. In addition, a guiding portion 24 for guiding the leading end of the braid 9 so as to get on the top of the insertion portion 16 when the ferrule is inserted is formed at the leading end of the insertion portion 16. The guiding portion 24 is formed by shaping the outer circumference of the leading end of the insertion portion 16 into a curved surface shape.

### Functions of Embodiment

Next, the functions of the wire harness 1 of this embodiment will be described.

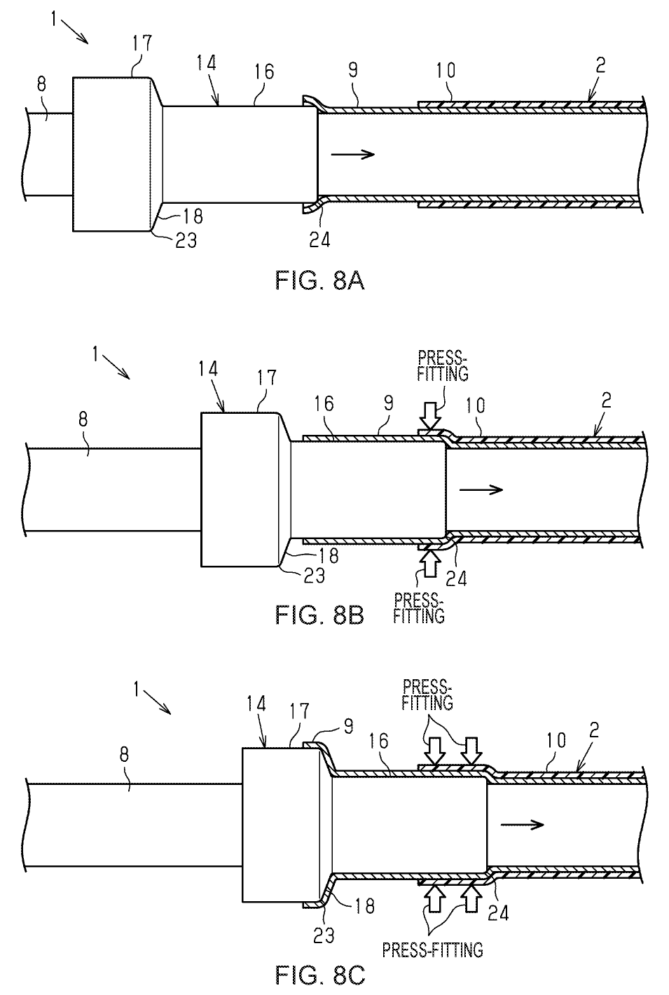

As shown in FIG. 8A, when the ferrule 14 is positioned relative to the electric wire 2 and fixed, the leading end of the insertion portion 16 of the ferrule 14 in which the outer circumferential surface of the insulating coating 8 of the electric wire 2 passes through the hole 15 is inserted into the space between the end portion of the braid 9 and the insulating coating 8. Then, the insertion into this space is continued by pressing the ferrule 14 linearly (in the direction indicated by an arrow in FIG. 8A) along the axis of the electric wire 2. In this example, the guiding portion 24 having a curved surface shape is formed at the leading end of the insertion portion 16, and therefore, the leading end of the insertion portion 16 is smoothly inserted into the space between the end portion of the braid 9 and the insulating coating 8.

As shown in FIG. 8B, when the leading end of the insertion portion 16 reaches the inside of the end portion of the sheath 10, insertion of the end portion of the insertion portion 16 between the insulating coating 8 and a portion where the braid 9 and the sheath 10 overlap each other is started. At this time, the leading end of the insertion portion 16 is inserted into the narrow space between the insulating coating 8 and the braid 9 to which a press-fitting load is applied from the sheath 10. Accordingly, the insertion of the insertion portion 16 is continued with a heavy insertion load being applied to the ferrule 14. Thus, the insertion portion 16 of the ferrule 14 is inserted into the narrow space between the insulating coating 8 and the braid 9 covered by the sheath 10.

As shown in FIG. 8C, when the leading end of the braid 9 reaches the wall portion 18 during the process of inserting the ferrule 14, the leading end of the braid 9 increases in the diameter by being guided to the tapered wall portion 18 and gets on the outer circumferential surface of the base end portion 17 of the ferrule 14. Then, the insertion of the ferrule 14 is continued until the ferrule 14 reaches a position at which the end portion of the sheath 10 limits the movement of the wall portion 18 of the ferrule 14, and thus the base end portion 17 of the ferrule 14 is located at the position closest to the sheath 10 (the state shown in FIG. 2). In this manner, the ferrule 14 is positioned relative to the electric wire 2.

### Inhibition of Locational Shifting of Ferrule 14

In this example, by inserting the insertion portion 16 of the ferrule 14 between the outer circumferential surface of the insulating coating 8 and a portion of the braid 9 covered by the sheath 10, the ferrule 14 is positioned relative to the electric wire 2 due to a press-fitting load applied from the sheath 10. Accordingly, locational shifting of the ferrule 14 is less likely to occur when the leading end of the braid 9 is fixed by swaging the fixing member 20 in a state in which the ferrule 14 is laid under the leading end of the braid 9. Therefore, the workability for assembling the wire harness 1 can be improved. As described above, the ferrule 14 can be positioned using a simple structure configured such that the insertion portion 16 of the ferrule 14 is inserted between the insulating coating 8 and the braid 9.

### Effects of Embodiment

With the wire harness 1 of the above embodiment, the following effects can be obtained.

1 The wire harness 1 includes the electric wires 2 that each include the braid 9, and the ferrules 14 that is each used for processing of the end of the braid 9. The end portion of the braid 9 is fixed using the fixing member 20 in a state in which the ferrule 14 is laid under the end portion of the braid 9. Each of the ferrules 14 has the insertion portion 16 that is inserted between the braid 9 covered by the sheath 10 and the outer circumferential surface of the insulating coating 8 and is positioned relative to the electric wire 2 before the fixation using the fixing member 20.

With this configuration, by inserting the insertion portion 16 formed in the ferrule 14 into the space between the insulating coating 8 and braid 9 of the electric wire 2, the ferrule 14 is positioned relative to the electric wire 2 due to a press-fitting load applied from the sheath 10 covering the braid 9. Accordingly, the locational shifting of the ferrule 14 is less likely to occur when another component is attached after the ferrule 14 has been attached to the electric wire 2. Therefore, the workability for assembling the wire harness 1 is improved. The ferrule 14 positioning structure is merely configured such that the insertion portion 16 formed in the ferrule 14 is inserted between the insulating coating 8 and the braid 9. Accordingly, the ferrule 14 can be positioned using a simple structure.

2 The insertion portion 16 has a tubular shape. With this configuration, in the insertion portion 16 of the ferrule 14, an area to which a press-fitting load from the sheath 10 is applied can be expanded in the circumferential direction of the ferrule 14, and it is thus possible to make it much less likely that the locational shifting of the ferrule 14 occurs.

3 The ferrule 14 has the base end portion 17 that has a larger diameter than the insertion portion 16 and is continuous with the insertion portion 16, and the wall portion 18 located at the boundary between the insertion portion 16 and the base end portion 17. The ferrule 14 is positioned relative to the electric wire 2 in the state in which the wall portion 18 is located at a position close to the end portion of the sheath 10. With this configuration, the position in the axial direction at which the ferrule 14 is disposed relative to the electric wire 2 is a position at which the wall portion 18 of the ferrule 14 is the closest to the end portion of the sheath 10. Accordingly, when the position of the ferrule 14 relative to the electric wire 2 is adjusted in the axial direction, the ferrule 14 need only be linearly moved to a position at which the wall portion 18 of the ferrule 14 cannot be moved due to the end portion of the sheath 10, and thus the ferrule 14 can be easily positioned. Also, due to a press-fitting load being applied to the insertion portion 16 from the sheath 10, the locational shifting of the ferrule 14 disposed at this position is less likely to occur.

4 The wall portion 18 has a tapered shape that tapers off toward the insertion portion 16 from the base end portion 17. With this configuration, when the insertion portion 16 of the ferrule 14 is inserted into the space between the insulating coating 8 and the braid 9, the leading end of the braid 9 is guided by the tapered wall portion 18 and smoothly reaches the base end portion 17 of the ferrule 14. Therefore, this configuration further contributes to an improvement in the workability for assembling the wire harness 1.

5 The corner portion 23 located at the boundary between the wall portion 18 and the base end portion 17 has a curved surface shape. With this configuration, when the insertion portion 16 of the ferrule 14 is inserted into the space between the insulating coating 8 and the braid 9, the leading end of the braid 9 is less likely to be damaged by the corner portion 23 of the wall portion 18 while the leading end of the braid 9 passes the corner portion 23.

6 The length L1 of the insertion portion 16 in the axial direction is set to a value that is two to three times as long as the length L2 of the base end portion 17 in the axial direction. With this configuration, in the insertion portion 16 of the ferrule 14, an area to which a press-fitting load from the sheath 10 is applied can be expanded in the axial direction of the ferrule 14, and it is thus possible to make it much less likely that the locational shifting of the ferrule 14 occurs.

### Other Embodiments

Note that this embodiment can be implemented with various modifications such as those described below. This embodiment and the following modified examples can be implemented in combination with each other as long as they are technically compatible with each other.

The shape of the base end portion 17 may be changed to another shape such as a bowl shape.

The diameter of the base end portion 17 can be changed from that of the example as appropriate.

The insertion portion 16 may have, for example, a shape with a step whose outer diameter changes at an intermediate portion in the axial direction.

The outer circumferential surface of the insertion portion 16 may have, for example, a tapered shape that tapers off toward the leading end.

The length L1 of the insertion portion 16 may be the same as the length L2 of the base end portion 17 or may be shorter than the length L2 of the base end portion 17.

The shape of the insertion portion 16 is not limited to the tubular shape, and may be, for example, a shape in which a plurality of legs extend from the base end portion 17.

The wall portion 18 may have a recessed portion with which the end portion of the sheath 10 is engaged together with the braid 9 when the positioning relative to the electric wire 2 is conducted.

There is no limitation to the configuration in which the ferrule 14 is disposed such that the wall portion 18 is located near the end portion of the sheath 10, and the wall portion 18 may be located at a position away from the end portion of the sheath 10.

The ferrule 14 may be a member having a simple cylindrical shape in which the insertion portion 16 and the base end portion 17 have the same diameter.

The fixing member 20 is not limited to a binding band such as a metallic tie band, and may be a member capable of fixing the braid 9.

The wire harness 1 is not limited to use in a vehicle, and may be used in a product or an apparatus other than a vehicle.

The present disclosure has been described in conformity with the example, but it is understood that the present disclosure is not limited to the example or the structure described above. The present disclosure also encompasses various modified examples and modifications within an equivalent scope. In addition, various combinations and forms as well as other combinations and forms that include only one element, or elements of not less than or not more than the number of the elements in the above-described combinations and forms fall within the scope of the present disclosure and the scope of the ideas of the present disclosure.

What is claimed is:

1. A wire harness comprising:
an electric wire that includes a core wire, an insulating coating that accommodates the core wire, a braid that covers the insulating coating, and a sheath that covers the braid; and
a tubular ferrule that is disposed between an end of the braid and the insulating coating, wherein
the end of the braid is fixed using a fixing member in a state in which the ferrule is laid under the end of the braid, and
the ferrule has an insertion portion that is inserted between the braid covered by the sheath and an outer circumferential surface of the insulating coating and is positioned relative to the electric wire before fixation using the fixing member.

2. The wire harness according to claim 1, wherein the insertion portion is formed in a tubular shape.

3. The wire harness according to claim 1, wherein the ferrule has:
a base end that has a larger diameter than the insertion portion and is continuous with the insertion portion; and
a wall located at a boundary between the insertion portion and the base end, and is positioned relative to the electric wire in a state in which the wall is located at a position adjacent to an end of the sheath.

4. The wire harness according to claim 3, wherein the wall has a tapered shape that tapers off toward the insertion portion from the base end.

5. The wire harness according to claim 3, wherein a corner portion located at a boundary between the wall and the base end has a curved surface shape.

6. The wire harness according to claim 3, wherein a length of the insertion portion in an axial direction is set to a value that is two to three times as long as a length of the base end in the axial direction.
